(19) United States
(12) Patent Application Publication
(10) Pub. No.: US 2025/0117665 A1
(43) Pub. Date: Apr. 10, 2025

(54) METHODS AND SYSTEMS FOR EVALUATING AND OPTIMIZING LARGE LANGUAGE MODELS AND METHODS FOR PERSONALIZED LARGE LANGUAGE MODELS

(71) Applicant: Trustees of Dartmouth College, Hanover, NH (US)

(72) Inventor: Varsha Shukla, Hanover, NH (US)

(21) Appl. No.: 18/911,219

(22) Filed: Oct. 9, 2024

Related U.S. Application Data
(60) Provisional application No. 63/543,282, filed on Oct. 9, 2023.

(51) Int. Cl. G06N 3/0895; G06N 3/0475

(52) U.S. Cl. CPC G06N 3/0895; G06N 3/0475

(57) ABSTRACT

A computer-implemented method for evaluating and optimizing a large language model (LLM) includes receiving input data for a large language model; transforming the input data into a standardized format compatible with a multi-metric evaluation framework; applying a set of evaluation metrics to the transformed data, wherein the set of metrics comprises a hallucination metric, a groundedness metric, a relevance metric, a recall metric, a precision metric, a consistency metric, and a Coherence metric; generating an error function that quantifies an overall performance of the LLM, wherein the error function takes as input parameters of the LLM and incorporates the set of evaluation metrics to produce an error score; minimizing the error function wherein a lower error score indicates better performance of the LLM; and outputting an improved LLM with improved parameters.

### CROSS-REFERENCE TO RELATED APPLICATIONS

This application claims priority to U.S. Provisional Application No. 63/543,282, filed on Oct. 9, 2023, now pending, the disclosure of which is incorporated herein by reference.

### FIELD OF THE DISCLOSURE

This disclosure relates to artificial intelligence (AI).

### BACKGROUND OF THE DISCLOSURE

Vibrant advances in Large Language Models (LLMs) are poised to transform fields as diverse as healthcare, education, science, engineering, and the humanities. However, maximizing the benefits of LLMs while preventing detrimental consequences requires additional research. Responsible, inclusive development of LLMs will democratize AI and actualize wide-ranging societal good.

LLMs are now evolving to handle multimodal data, allowing them to process text, images, and audio simultaneously. The widespread application of multimodal LLMs can be seen in sectors such as healthcare, finance, legal documentation, and customer service. Despite the progress, a critical challenge remains: evaluating these models in a way that captures their multimodal capabilities while ensuring fairness, accuracy, and efficiency. Current approaches to evaluation are often subjective, heavily manual, and fail to generalize across different data types. These limitations can lead to biased or incorrect assessments, which are particularly damaging in high-stakes industries like healthcare or finance.

### BRIEF SUMMARY OF THE DISCLOSURE

Embodiments disclosed herein include a personalized language model powered by artificial intelligence, which can be configured for transformative commercial applications. This language model can enhance knowledge sharing, research, and decision-making in commercial and industrial domains with an individual's or a company's proprietary knowledge.

An AI-Chat model can facilitate the creation of a knowledge repository. This repository allows individuals and companies to quickly access personalized and confidential solutions, fostering efficient information retrieval and monetization of expertise. Additionally, it leverages generative AI (GenAI) to extract valuable insights from an individual's or company's proprietary data, personal files, and/or technical documents without having to upload these data. files, or documents on the cloud. This also can be used to do market research and make development decisions, identify spaces for innovation, and provide a strategic advantage to organizations operating in the global digital solutions landscape. The AI-Chat model can collect and organize confidential and proprietary data, enabling swift information retrieval and monetization opportunities. By employing GenAI to analyze personal files, proprietary data, and other publicly available information, insights can be uncovered and market opportunities can be identified.

Embodiments disclosed herein may include the integration of AI-Chat and GenAI for knowledge repository creation and insight extraction. This addresses challenges in today's rapidly evolving digital landscape and empowers organizations to stay competitive and innovative.

Embodiments of the present disclosure provide automated, real-time evaluation mechanisms for multimodal LLMs based on metrics including one or more of: Hallucination, Groundedness, Relevance, Recall, Precision, Consistency, and Coherence. The technology aligns with IEEE standards, offering highly accurate, fair, and efficient evaluation models that can be optimized in real time. In some embodiments, present disclosure provides a comprehensive technology that addresses these challenges by automating the evaluation of multimodal LLMs using a set of robust, mathematically grounded metrics. These metrics are designed to capture not only the accuracy of a model's output but also its coherence across different modalities, its ability to avoid hallucinations, and its alignment with human judgments. This technology provides an automated mechanism for optimizing models continuously based on real-time feedback, thereby improving model performance in a scalable and systematic manner.

Embodiments of the present technology provides a comprehensive, automated solution for evaluating and optimizing multimodal Large Language Models. By introducing mathematically grounded metrics such as Hallucination, Groundedness, Relevance, Recall, Precision, Consistency, and Coherence, the technology ensures that multimodal LLMs are evaluated fairly, accurately, and efficiently. Through continuous optimization based on real-time feedback, the technology offers significant improvements over existing methods, leading to faster, more reliable deployment of AI models across various industries.

### DESCRIPTION OF THE DRAWINGS

For a fuller understanding of the nature and objects of the disclosure, reference should be made to the following detailed description taken in conjunction with the accompanying drawings.

FIG. 1: A chart showing a method according to an embodiment of the present disclosure: and

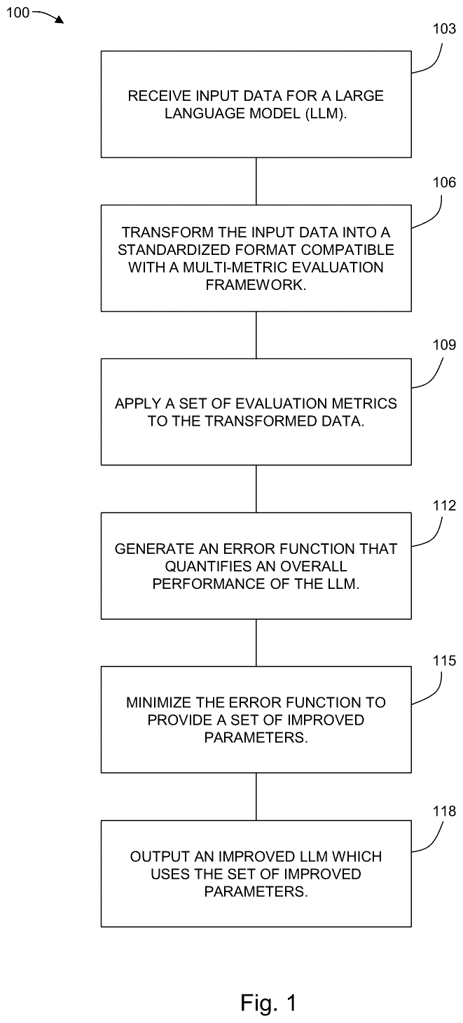

FIG. 2: A series of charts and graphs indicating research statistics.

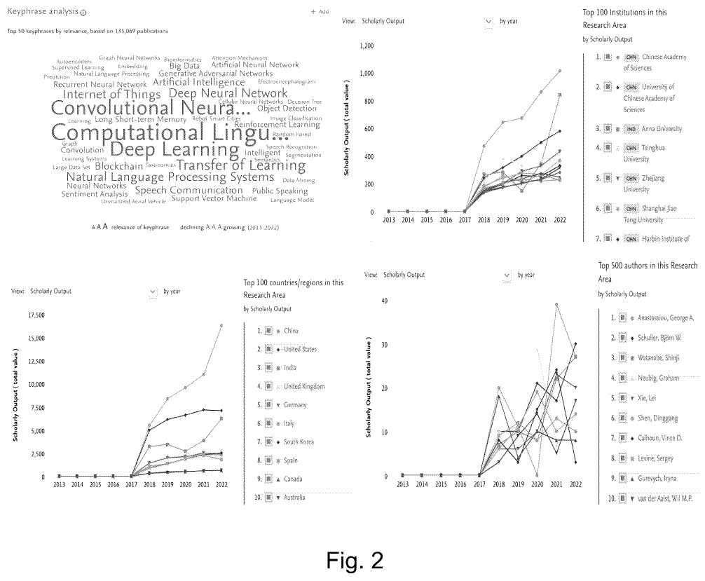

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

LLM and GenAI are integrated in the embodiments disclosed herein. LLM can facilitate the creation of a dynamic knowledge repository. GenAI can add a layer of intelligence to analyze personal files, proprietary data, and publicly available information. This integration enables not only the collection of data but also the extraction of valuable insights from diverse sources. The integrated system and its operation not only gathers data efficiently, but also can analyze and generate recommendations from it. This comprehensive approach extends to conducting market studies, which can help users access, analyze, and act upon data.

Embodiments of the present disclosure may train an LLM on information, such as, but not limited to, documents, data, and files. For example, the information may be related to a specific organization. In embodiments, a personalized LLM may be generated and used by the organization. This LLM may be broad and scalable. The combination of LLM and GenAI allows for a more versatile and context-aware content generation, making it suitable for various applications in various industries. The present disclosure has applications beyond document confidentiality.

LLM models such as, but not limited to, BERT, OpenAI, TS, PaLM, or LLaMA, may be integrated into the embodiments disclosed herein. Embodiments of the system may accommodate multiple and different LLM architectures and scales.

Embodiments of the present disclosure may integrate various GenAI models. For example, embodiments may generate content based on user input or preferences, such as text generation models, image generation models, and/or multimodal models. Embodiments of the system disclosed herein allows for seamless communication between the LLM and GenAI. The GenAI component takes user input or context and generates content, which the LLM then uses to enhance and further refine the generated content. The integration involves data flow, preprocessing, and post-processing steps to ensure coherent and contextually relevant results.

Embodiments of the system disclosed herein may operate by a series of customizations, such as, but not limited to, defining specific communication protocols between the LLM and GenAI components, optimizing the preprocessing steps for the input data, and fine-tuning the LLM for improved content refinement. These customizations may achieve the desired level of performance and synergy between the LLM and GenAI components.

Specific communication protocols can be defined to provide seamless communication between the LLM and GenAI components. These protocols govern how data flows between the two components, which provides efficient collaboration and information exchange between private data and the LLM without having to upload the private data on the cloud. This can maintain confidentiality.

Preprocessing steps can enhance the quality and relevance of the input data. The preprocessing steps can be optimized to provide data cleaning, normalization, and structuring. This can ensure that the LLM and GenAI can work with the private data effectively.

Fine-tuning the LLM may be a continuous process aimed at improving content refinement. The LLM can be fine-tuned to make it more context-aware and adaptable to various applications and industries. This fine-tuning process can contribute to the overall performance of the system.

Traditional knowledge-sharing platforms often lack efficiency and do not maintain confidentiality. The LLM allows for quick access to personalized and confidential solutions. Integration of the LLM with GenAI ensures that valuable insights can be gleaned from confidential data without the need to upload it to the cloud. This can safeguard sensitive information. Sensitive information can be maintained on a user's network. While some existing technologies may focus on specific aspects like data collection or market analysis, embodiments disclosed herein can provide a multifaceted solution. Embodiments disclosed herein can combine data collection, analysis, recommendation generation, and market research into one cohesive system.

By using the LLM, individuals and companies can rapidly retrieve non-confidential solutions, reducing the time and effort required to find information, and ultimately increasing productivity.

Many individuals and businesses hesitate to upload sensitive data to the cloud due to security concerns. Embodiments disclosed herein can enable the extraction of valuable insights from personal files and proprietary data without compromising security. Files can remain on a user's server and do not need to be uploaded. This advantage ensures the confidentiality and integrity of sensitive information.

Compatible APIs and connectors for popular platforms and/or systems can be developed to integrate an embodiment of the disclosed system with an organization's existing software and data infrastructure.

Best practices, industry standards, and compliance with data protection regulations, such as GDPR or HIPAA, can be maintained.

### Introduction:

Natural language processing (NLP) enables machines to comprehend and generate human language, forming a crucial aspect of artificial intelligence research. Language modeling lays the foundation for NLP by developing statistical models to predict word sequences based on the premise that closer words have greater correlation. Early language modeling research in the 1950s-1960s was predominantly rule-based relying on handcrafted linguistic features. In the 1980s-1990s, statistical n-gram models gained prominence by estimating word probabilities conditioned on previous n−1 words. However, these models were restricted by data sparsity for longer contexts. The advent of neural networks revolutionized language modeling by effectively handling semantically richer long-range dependencies in text.

Recurrent neural networks (RNN) enabled modeling term dependencies regardless of distance by processing text sequentially using recurrent hidden states. Long short-term memory (LSTM) RNNs further overcame issues of vanishing gradients. Feedforward networks like ELMo and ULMFiT were also explored for language modeling. Nevertheless, RNN models were limited by sequential computation and challenges in parallelization.

Attention mechanisms fundamentally transformed language modeling by allowing direct modeling of dependencies between all input and output tokens, regardless of position. The seminal Transformer architecture leveraged attention and deep neural networks to achieve state-of-the-art results surpassing RNNs. Attention-based Transformers facilitated parallelization and capture of long-range contexts.

Subsequent work has progressively scaled up Transformers, training them on ever-larger datasets. Models exceeding hundreds of billions of parameters, called large language models (LLMs), have been developed like GPT-3, Jurassic, PaLM and LLAMA. LLMs have obtained human-level language understanding across diverse NLP tasks. Pre-training objectives like masked language modeling and replaced token detection have improved their capabilities. Both decoder-only autoregressive and encoder-decoder Transformer architectures have been successful. Innovations like sparse attention, mixture of experts, and floating point optimizations have enabled scaling LLMs up.

This survey analyzes key developments in LLMs concerning model architectures, training techniques, performance evaluation, diverse applications, and ethical implications. We discuss the future outlook on LLM research and strategies to address limitations like bias, safety, and environmental impact. The insights from this survey intend to guide researchers and developers towards responsibly harnessing the potential of LLMs and shaping the path ahead.

### LLM Architectures:

Most modem LLMs are based on the Transformer architecture. Transformer networks rely entirely on attention mechanisms to model dependencies in an input sequence. The standard Transformer comprises an encoder and decoder. The encoder maps an input token sequence to a sequence of continuous representations focusing on capturing context. The decoder autoregressively generates an output sequence token-by-token conditioned on the encoder output. Attention layers allow each token to directly interact with all other tokens, enabling parallelization and learning long-range dependencies critical for language modeling. Variants of the Transformer architecture used in LLMs include:
Bidirectional Encoder Representations from Transformers (BERT): BERT leverages only the Transformer encoder trained on masked language modeling and next-sentence prediction tasks. It incorporates bidirectional context for understanding sentence meaning.
Generative Pretrained Transformer (GPT): GPT uses the Transformer decoder trained as an autoregressive language model to predict subsequent tokens. GPT is suited for natural language generation applications.
Text-to-Text Transfer Transformer (T5): T5 employs both the encoder and decoder, training on a denoising objective by reconstructing corrupted text. T5 reformulates all NLP tasks as text-to-text problems.
PaLM: PaLM introduces an efficient mixture-of-experts architecture with sparse attention enabling training models with over 500 billion parameters.

### LLM Training:

LLMs are trained on massive text corpora using self-supervised objectives requiring no human annotations. Pretraining objectives include:
Autoregressive language modeling: Models sequentially predict the next token given previous tokens.
Masked language modeling: Certain input tokens are masked, and the model must reconstruct them from context.
Denoising autoencoding: The model must reconstruct the original text from corrupted versions.

Self-supervised pretraining enables LLMs to learn universal linguistic representations. It is followed by task-specific fine-tuning on downstream datasets using labeled data. Fine-tuning adapts the model to specialized domains like biomedical text classification or sentiment analysis. Efficient pretraining techniques for LLMs include bilevel optimization, sparse attention, a mixture of experts, and block-wise attention. The training computational requirements of LLMs pose challenges, demanding substantial high-performance computing infrastructure. Quantization, pruning, knowledge distillation, and hardware-software co-design help improve training efficiency.

### Applications of LLMs:

The versatile capabilities of LLMs have catalyzed breakthroughs across diverse domains:
Healthcare: Clinical decision support, medical question answering, extraction of insights from patient records.
Education: Intelligent tutoring systems, automated assessment, and educational content creation.
Finance: Risk modeling, algorithmic trading, financial document understanding.
Engineering: Code generation and completion, improved software engineering workflows.
Scientific Research: automated literature review, hypothesis generation, scientific writing assistance.

LLMs present lucrative commercial opportunities. LLM-based applications like chatbots for customer engagement, generative art creation, and automated content generation have gained investment traction. Principled development and deployment of LLMs remain vital considering their societal ramifications.

### Limitations and Challenges:

Despite their promise, LLMs have shortcomings that motivate further research:
Bias and Fairness: Models inadvertently perpetuate and amplify biases in training data related to gender, race, culture etc.
Interpretability: The reasoning behind LLM outputs is opaque and needs transparent explanations for trust.
Safety: Potential for generating harmful, unethical or untruthful content needs prevention.
Environmental Impact: LLMs have exorbitant training computational costs with implications for carbon emissions.
Data Privacy: Collection and use of large user data for training raise privacy concerns requiring safeguards.

### Future Outlook:

Active research frontiers that will shape the future progress of LLMs include:
Multi-tasking: Developing models capable of excelling at a broad range of tasks using unified model architectures.
Multimodal: Incorporating modalities like vision and audio alongside text.
Knowledge Integration: Effectively incorporating structured, factual knowledge into models.
Common Sense and Reasoning: Improving logical reasoning capabilities.
Meta-Learning: Enabling rapid learning from fewer examples and past experiences.
Personalized Resource Settings: Architectures and training approaches optimized for personalized data scenarios.

The vibrant advances in LLMs are poised to transform fields as diverse as healthcare, education, science, engineering, and the humanities. However, maximizing the benefits of LLMs to society while preventing detrimental consequences obliges principled and ethical research into the considerations highlighted in this survey. Responsible, inclusive development of LLMs will pave the path ahead for democratizing AI and actualizing wide-ranging societal good.

### Personalized Large Language Models

Large language models (LLMs) have rapidly advanced natural language processing capabilities, exemplified by systems like GPT-3 and ChatGPT. However, most LLMs are generalized models trained on broad corpora. Recent work has explored personalizing LLMs using individuals' data to enhance relevance for specific users. This section analyzes progress in LLMs, the potential for personalized models, industrial applications, and ethical considerations.

### LLM Advances

LLMs have evolved tremendously, with models scaling up in size from millions to billions of parameters. Architectures like attention mechanisms, transformers, and sparsely gated mixture of experts have enabled training massive models. Techniques including self-supervised pretraining, meta-learning, transfer learning, and reinforcement learning from human feedback have improved model capabilities. LLMs leveraging these advances have achieved strong performance on question answering, dialogue, code generation, content creation, and other language tasks.

Recent models incorporate specialized knowledge using pretrained scientific corpora, multimodal information, and logic to enhance reasoning. Efforts to reduce environmental impact focus on model efficiency and distillation. Work on controllable text generation aims to improve safety. There remains active research into limitations of LLMs including robustness, interpretability, and bias. The vibrant evolution of LLMs continues, with models becoming more powerful, generalizable, and aligned to human preferences.

### Personalized LLMs

While most LLMs are trained on broad corpora, personalized models fine-tuned on an individual's data can improve relevance and capabilities. Personalized LLMs have been explored for email, scientific writing assistance, Stylistic text generation, and personalized recommendations. These leverage an individual's inbox, academic papers, social media posts, or product reviews for fine-tuning. Personalized LLMs increased satisfaction and preference over non-personalized models in studies.

Challenges include data scarcity, privacy, and training costs. Federated learning and meta-learning help tackle limited user data. Differential privacy mechanisms can safeguard data privacy. Efficient training methods like distillation and pruning reduce computational requirements. Overall, personalized LLMs remain an emerging area with rich potential to tailor models to user needs and contexts. Personalization can enhance relevance in applications like conversational agents, content creation, and search.

### Future Opportunities

Major open challenges include training customized models with extremely sparse user data. Techniques like few-shot learning, life-long adaptation, and multitasking training can potentially enable learning from limited samples. Ensuring privacy is also crucial, demanding federated approaches and differential privacy techniques. Personalized models will need standardized benchmarks and rigorous testing to evaluate safety, fairness and robustness for diverse users. Deploying personalized LLMs demands efficient training, updating, and portability across devices. Overall, ample opportunities exist to advance personalized LLMs and translate progress into real-world applications.

### Applications

Potential applications of customized LLMs include:
Personalized writing assistants that capture an individual's style and domain.
Conversational agents like ChatGPT fine-tuned on a user's dialog history and interests.
Intelligent tutors that adapt to students' knowledge levels and learning patterns.
Product recommendation systems utilizing an individual's reviews and purchase history.
Email automation systems tailored to a person's vocabulary, tone and messaging patterns.
Bioinformatics tools leveraging a scientist's publications and lab datasets.

As personalized LLMs mature, they can enhance customization in diverse domains while reducing the need for manually profiling users.

### Ethics and Risks

Personalized LLM usage demands considering privacy, bias, and consent:
Privacy: Models trained on private data may inadvertently expose or leak that data despite protections.
Bias: Models could perpetuate and amplify biases specific to an individual's data.
Informed Consent: Clear protocols and protections are needed to ensure voluntary and informed user consent for data collection.
Right to Be Forgotten: Mechanisms to enable users to revoke consent and have their data securely erased from models.
Security: Preventing unauthorized access or modification of personalized models.

Overall, while personalized LLMs have immense potential, their development and deployment necessitates safeguarding individuals' agency, privacy and consent.

### Comprehensive Framework for Developing a Personalized Large Language Model (LLM) Using the LLAMA Framework and Azure OpenAI

This section presents a comprehensive framework for developing a personalized Large Language Model (LLM) tailored to the task of mining information from public filings. The code and methodologies discussed herein involve the integration of the LLAMA indexing framework and the Azure OpenAI service. By utilizing these technologies, we construct a sophisticated LLM that can provide detailed and contextually relevant responses to specific queries related to data extraction.

### Introduction:

The objective of this research is to design and implement a personalized LLM capable of extracting information from publicly available documents, particularly public filings. The code presented here achieves this by combining the capabilities of LLAMA and Azure OpenAI, resulting in an LLM that can comprehend and respond to queries related to data.

### Installation of Required Libraries:

We begin by installing essential Python libraries using the pip package manager. Specifically, we install llama-index, langchain, and openai. These libraries are instrumental in building and configuring the personalized LLM.

### Configuration of Azure OpenAI:

The Azure OpenAI service is configured by setting environment variables. These variables include OPENAI_API_TYPE, OPENAI_API_VERSION, OPENAI_API_BASE, and OPENAI_API_KEY. OPENAI_API_TYPE specifies the type of API to be used, OPENAI_API_VERSION denotes the API version, OPENAI_API_BASE defines the API endpoint, and OPENAI_API_KEY is the authentication key required for interaction with the Azure OpenAI service.

### Creation of Azure OpenAI Instance:

An instance of Azure OpenAI is instantiated using the AzureOpenAI class from the langchain.llms module. This instance is specifically configured to interface with the “gtmembed” deployment and the “text-davinci-003” model, ensuring that the LLM is appropriately tuned for text generation.

Index Building with LLAMA:

The core of this research involves constructing an index to facilitate efficient information retrieval. This is achieved using the LLAMA framework. The KeywordTableindex is employed to build the index from a collection of documents located in the/content/sample_data/test directory. These documents are expected to contain pertinent and public filing data.

### LLM Predictor Configuration:

The LLMP Predictor is configured to utilize the Azure OpenAI instance (llm) previously created. The predictor plays a pivotal role in generating text-based responses from the personalized LLM, ensuring that the responses align with the specific requirements of mining information from public filings.

### Service Context Setup:

The ServiceContext is established with default settings, incorporating the LLM predictor. This context enables the management of the personalized LLM's behavior and response generation, further enhancing its adaptability to the task at hand.

### Querying the Index:

With the index and LLM predictor in place, we proceed to execute queries on the indexed data. The query_engine is utilized to interrogate the index for relevant information. Questions such as “What is the gross margin?” and “What information does the file have on the sustainability goals of the company” are presented to the personalized LLM.

### Output Display:

The responses generated by the personalized LLM are captured and displayed as output. These responses represent the LLM's ability to understand and interpret specific queries related to data from public filings.

### Conclusion:

This research showcases the successful integration of the LLAMA framework and Azure OpenAI to create a specialized LLM for mining information from public filings. The code, libraries, and methodologies discussed herein provide a valuable foundation for developing domain-specific LLMs tailored to various industries and knowledge domains.

### The Novel Aspects of a Personalized or Custom Large Language Model (LLM) That is Trained on Individual or Organization-Specific Data

Large Language Models (LLMs) have undergone remarkable advancements in recent years, transforming the landscape of natural language understanding and generation. In this section, we explore the unique features that distinguish the personalized or custom LLM presented in this research.

### Data-Driven Personalization

One of the standout features of the personalized or custom LLM is its data-driven personalization. Unlike conventional LLMs that rely on general pre-training data, this LLM is fine-tuned and trained on individual or organization-specific data. This data-driven personalization enables the LLM to comprehend and generate text that is highly context-aware and aligned with the unique requirements of the user or organization.

The Custom LLM discussed here can adapt to various information domains and is finely tuned to capture the nuances of the data it has been trained on, making it an exceptionally valuable tool for organizations and individuals with specific data needs. This data-driven personalization is a novel aspect that significantly enhances the LLM's ability to provide context-aware responses tailored to individual information requirements.

### Integration of LLAMA Framework

Another innovation in this research is the integration of the LLAMA framework for document indexing and retrieval. Although LLMs have been widely applied in natural language processing tasks, the inclusion of LLAMA, a novel indexing technology, represents uncharted territory. LLAMA offers several advantages, including efficient keyword-based document retrieval, which is particularly valuable for information extraction tasks.

By incorporating LLAMA, this personalized or custom LLM achieves superior performance in terms of data mining and document retrieval. The LLM can swiftly locate and extract relevant information from extensive document collections based on personalized training data, a capability that is not typically found in traditional LLM configurations.

### Hybrid AI Architecture

The personalized or custom LLM described here features a groundbreaking hybrid AI architecture. It combines the language generation capabilities of Azure OpenAI with the indexing and retrieval power of LLAMA. This hybrid architecture harnesses the strengths of both technologies, resulting in a more adaptable and effective LLM.

While standalone LLMs excel in generating text, they may lack the proficiency to efficiently navigate and extract knowledge from large document repositories. The inclusion of LLAMA bridges this gap, enabling the LLM to both comprehend and extract insights from unstructured text data based on personalized training.

### Tailored Responses to Specific Queries

A significant innovation of this personalized or custom LLM is its capacity to provide tailored responses to a wide array of queries, regardless of the domain. It can answer questions with context-aware, data-specific insights. This customization is achieved through meticulous curation of training data, fine-tuning of the LLM's parameters, and integration with data-driven knowledge.

By adapting responses to the query context based on personalized training data, the Custom LLM becomes an indispensable tool for professionals and organizations seeking precise and relevant information. This level of personalization underscores the potential of data-driven fine-tuning to cater to the unique requirements of various applications.

### Conclusion:

This survey has presented a landscape of the origins, evolution, capabilities, applications, limitations and future horizon of LLMs. We outlined the progression of language modeling from statistical to neural approaches, dominated today by Transformers and attention. Architectural innovations in LLMs were analyzed through models like BERT, GPT, T5, PaLM and others. Pretraining strategies, applications across domains, and limitations around bias, privacy and the environment were discussed. Recent trends indicate scope for multi-tasking. multimodal, common-sense reasoning and low resource LLMs. Advancing research and development responsibly while addressing challenges will maximize the benefits of LLMs for humanity. This survey aimed to equip researchers with a comprehensive perspective on LLMs to shape progress and positive impact.

The personalized or custom Large Language Model developed in this research distinguishes itself as an innovative solution for addressing information needs across diverse domains. Its data-driven personalization, integration with the LLAMA framework, hybrid AI architecture, and capacity to deliver tailored responses represent the novel contributions of this work. This Custom LLM not only demonstrates the power of data-driven fine-tuning but also underscores the importance of combining different AI technologies to achieve superior performance in specialized and versatile natural language processing tasks based on personalized or custom training data.

### EVALUATION AND OPTIMIZATION FRAMEWORK

### Existing Metrics for Text Evaluation

Traditional evaluation metrics like BLEU (Bilingual Evaluation Understudy) and ROUGE (Recall-Oriented Understudy for Gisting Evaluation) have long been used to evaluate the performance of text-based models by measuring the n-gram overlap between model-generated output and reference texts. However, these metrics exhibit several critical limitations, particularly when applied to large language models (LLMs) that are expected to handle more complex and nuanced tasks. Key issues include:

Overemphasis on Lexical Similarity: Both BLEU and ROUGE primarily measure the degree of word overlap between the generated and reference texts. While this approach works well for certain translation and summarization tasks, it fails to account for deeper semantic understanding. Lexical overlap does not necessarily reflect whether the generated content conveys the same meaning as the reference, especially in cases where paraphrasing, synonym usage, or more abstract reasoning is involved.

Inability to Capture Contextual and Semantic Accuracy: As language models become more advanced, there is a growing need to assess how well they capture context and meaning, rather than just how closely they match a reference text on the surface. BLEU and ROUGE fall short in measuring whether a model's response is contextually appropriate or whether it exhibits coherence across sentences and paragraphs, which are crucial for tasks such as dialogue generation, storytelling, or complex question answering.

Lack of Suitability for Multimodal Models: These traditional metrics are designed for text-only tasks and are inherently incapable of evaluating multimodal models that require the integration of various data types (e.g., text, images, and audio). For instance, BLEU and ROUGE do not account for the alignment between text generated from visual or auditory data, rendering them unsuitable for evaluating models that process multimodal inputs or outputs.

Subjectivity and Inconsistency in Human Evaluation: Human evaluation, which often supplements automated metrics, introduces a high degree of subjectivity. Different human evaluators may interpret and score the quality of generated text differently, leading to inconsistent assessments. The lack of standardized criteria in manual evaluations further complicates the process, as human evaluators may prioritize different aspects of the output, such as fluency, creativity, or factual correctness, depending on their background and preferences.

These limitations highlight the inadequacy of traditional text evaluation methods for assessing modern LLMs, which are increasingly being used for sophisticated and diverse applications that go beyond simple text generation tasks.

### Challenges in Multimodal Model Evaluation

The rise of multimodal models, which process and generate multiple forms of data (e.g., text, images, audio), demands more complex evaluation frameworks than those used for text-only models. These models not only need to generate accurate and coherent text but also must ensure that the generated text is well-aligned with non-textual inputs. However, current evaluation methods are not equipped to handle the unique challenges posed by these multimodal systems. The challenges include:

Cross-Modal Coherence and Consistency: Evaluating multimodal models requires assessing how well the model integrates and aligns information from multiple data sources. For example, in tasks such as image captioning, a model must generate text that accurately reflects the content of an image, while for video analysis, it must generate text that describes both the visual and audio components. Existing text-based metrics do not consider whether the generated text correctly corresponds to the non-textual input, leading to incomplete or misleading evaluations. This cross-modal coherence is crucial for a wide range of applications, including autonomous systems, human-computer interaction, and multimodal content creation.

Lack of Standardized Multimodal Metrics: While text-based evaluation has established metrics (albeit limited), the multimodal field lacks universally accepted benchmarks and metrics that can evaluate the synergy between different data types. Current approaches often rely on ad hoc evaluations or custom metrics that vary between researchers and tasks. This lack of standardization makes it difficult to compare model performance across different datasets and applications, hampering the progress of multimodal AI research.

Dynamic vs. Static Evaluation: Many existing evaluation methods are static, meaning that after generating an output, the model is evaluated post-hoc, and the developer must manually adjust the model to improve performance. This static approach introduces inefficiencies in model development, as iterative adjustments are slow and resource intensive. It also introduces potential biases, as developers may focus on optimizing the model for specific static metrics without capturing the broader range of performance factors that are important in real-world applications.

Bias in Human-Generated Feedback: For multimodal tasks, where human evaluation is often used to assess the quality of the model's output, biases in the evaluation process become even more prominent. Evaluators may have varying interpretations of how well the model aligns text with non-textual data, leading to subjective and inconsistent evaluations. The criteria for assessing multimodal alignment—such as the relevance of text to an image or the emotional tone conveyed in audio—can vary significantly between evaluators, further complicating the development of robust evaluation metrics.

Latency in Model Adjustment: Traditional evaluation frameworks often require developers to manually fine-tune their models after receiving evaluation results, introducing delays in optimizing performance. This manual tuning process is not only time-consuming but also prone to errors, as the feedback loop between evaluation and optimization is slow and inefficient. In fast-paced industries like autonomous systems, real-time response is critical, and delays in optimization can have serious consequences for deployment and application.

### Present Solution: Automated Evaluation and Optimization

### Metrics for Multimodal LLM Evaluation

In the evaluation of multimodal large language models (LLMs), traditional metrics used for text-based models are insufficient due to the complexity of processing multiple data modalities (e.g., text, images, audio). Embodiments of the present evaluation framework introduce a set of core metrics specifically designed to assess the performance of multimodal LLMs. These metrics capture various aspects of output quality, including, for example, factual accuracy, relevance, and consistency across different input types. Each metric plays a critical role in understanding how well a model integrates and processes multimodal data, ensuring the output is both semantically and contextually aligned with the input.

### 1. Hallucination (H):

Hallucination refers to the phenomenon where a model generates information not present or supported by the input data. In multimodal LLMs, hallucination can occur when the model incorporates irrelevant or incorrect details that do not correspond to the input, whether it's visual, auditory, or textual. This is a crucial metric, especially in applications where factual accuracy is paramount (e.g., medical or legal document generation).

The Hallucination score (H) is calculated by comparing the model's output with the input data across all modalities, identifying discrepancies where the output introduces unsupported information. The mathematical formulation can be expressed as:

$$H = \frac{Number of unsupported elements in output}{Total elements in output}$$

A higher hallucination score indicates a larger deviation from the input data, suggesting poor model alignment with the provided information. Reducing hallucination is critical for maintaining the integrity of multimodal systems.

### 2. Groundedness (G):

Groundedness evaluates the degree to which the model's output is based on verifiable, factual information. In the context of multimodal LLMs, groundedness ensures that the generated output, whether text, image descriptions, or audio transcriptions, is anchored in reality and is not speculative or fabricated.

The groundedness metric can be computed by verifying the alignment of model outputs with known facts or ground-truth data. Techniques such as fact-checking APIs or external knowledge bases (e.g., Wikipedia or domain-specific databases) can be used to validate the output. Mathematically, groundedness can be represented as:

$$G = \frac{Number of verifiable facts in output}{Total number of facts presented in output}$$

A score closer to 1 indicates a higher degree of factual grounding, making it a crucial metric in contexts where truthfulness and data integrity are key.

### 3. Relevance (R):

Relevance assesses how closely the model's output matches the input query or task. In multimodal LLMs, relevance spans multiple modalities and ensures that the generated text, image descriptions, or audio transcripts are contextually related to the given input. This is particularly important when dealing with complex queries that involve cross-referencing different data types.

To compute relevance, semantic similarity between the input and the output is calculated using embedding-based models like BERT (Bidirectional Encoder Representations from Transformers) or SBERT. The embeddings capture the deep semantic meaning of both the input and the output, and the cosine similarity between the embeddings provides a relevance score: (using cosine similarity) where A and B are the embedding vectors of the input and output, respectively.

$$R = cos θ = \frac{A \cdot B}{‖ A ‖ ‖ B ‖}$$

A relevance score close to 1 indicates high alignment between input and output, suggesting that the model is effectively handling multimodal data and producing contextually appropriate responses.

### 4. Recall (Rec):

Recall measures the model's ability to retrieve all relevant information from the input data, particularly when dealing with large and complex datasets. In multimodal LLMs, recall is essential to evaluate whether the model is capturing all necessary elements from multiple data types (text, images, audio) and accurately reflecting them in the output.

Recall is mathematically expressed as:

$$Recall = \frac{Number of Relevant Documents Retrieved}{Total Number of Documents in Corpus}$$

A high recall score indicates that the model is effectively retrieving and incorporating all the relevant data in its output. In multimodal tasks, this could involve retrieving specific details from images, audio cues, or text and ensuring that none of the critical information is missed.

### 5. Precision (P):

Precision measures the accuracy of the model's retrieval of relevant information by assessing how much of the information retrieved is actually useful or correct. In the context of multimodal LLMs, precision is crucial to ensure that only the most pertinent and accurate elements from the input data are included in the output.

Precision is defined as:

$$Precision = \frac{True Positives}{True Positives + False Negatives}$$

High precision indicates that the model is not only retrieving relevant information but is also avoiding the introduction of irrelevant or incorrect data, making it particularly important in tasks like summarization, caption generation, or context-based question answering.

### 6. Consistency (C):

Consistency assesses whether the model produces uniform and coherent outputs across different inputs or over repeated queries. In multimodal LLMs, consistency is especially important when generating outputs from varied data inputs, such as generating text based on images and then generating the same text from similar audio input. The output should remain stable and logically coherent across these variations.

Consistency is measured by comparing outputs from similar or identical inputs under different conditions, with the goal of minimizing variability. It can be quantified by using variance or entropy measures:

$$C = 1 - \frac{Variance of outputs across inputs}{Mean of outputs across Inputs}$$

A higher consistency score suggests that the model generates stable, predictable outputs regardless of minor input variations, which is critical for real-time applications that demand reliability.

### 7. Coherence (Co):

Coherence refers to the logical flow and structure of the model's output, ensuring that the generated text is not only factually correct and relevant but also easy to follow and logically constructed. Coherence is especially important in tasks such as storytelling, dialogue generation, or complex instruction generation, where the output must maintain a smooth narrative or argument.

Coherence is often evaluated using measures like entity tracking (to ensure entities are consistently referred to throughout the text) and discourse structure analysis. Automated tools that assess sentence transitions and overall text structure can be used to compute coherence, with higher scores indicating better-structured and logically sound outputs.

$${C}_{o} = Discourse Coherence Score + Entity Tracking Accuracy$$

A high coherence score reflects a model's ability to generate text that is not only accurate and relevant but also logically structured, making it easy for users to understand.

These metrics—Hallucination, Groundedness, Relevance, Recall, Precision, Consistency, and Coherence—provide a comprehensive framework for evaluating multimodal LLMs. By focusing on key aspects such as factual accuracy, cross-modal alignment, and output consistency, these metrics enable a more robust and nuanced assessment of model performance, ensuring that the generated content meets the diverse and complex requirements of real-world applications.

### Theoretical Basis of the Technology

A fundamental goal of the presently disclosed technology is to automate the evaluation of multimodal Large Language Models (LLMs) in a manner that ensures fairness, accuracy, and efficiency. The core logic behind the technology is based on combining statistical analysis and deep learning techniques to evaluate the outputs of LLMs in a consistent and objective manner. Multimodal models present a unique challenge because they integrate multiple forms of data, including text, images, and audio, each of which requires its own distinct evaluation criteria.

### Multimodal Data Representation

In traditional LLMs, the input data is typically a single modality, such as text. In multimodal models, multiple modalities (e.g., text and images) are processed simultaneously, with the goal of producing outputs that reflect an understanding of the combined information. The core of this technology lies in how multimodal data is represented and evaluated.

To process multimodal data, embodiments of the present disclosure use embeddings, which are vector representations of the data. For example, images can be represented by feature vectors generated using convolutional neural networks (CNNs), while text can be represented using embeddings such as BERT or GPT embeddings. These vector representations allow us to calculate meaningful metrics such as similarity (e.g., cosine similarity) between different types of input and output data.

### Evaluation Metrics Logic

Each of the evaluation metrics introduced above has its theoretical foundation in widely accepted mathematical principles and AI concepts. The combination of these metrics provides a comprehensive picture of how well a model is performing across multiple dimensions.

### 1. Hallucination Detection

Hallucination detection is based on semantic anomaly detection. The logic is straightforward: if the content generated by the model deviates significantly from the input or the provided factual information, it is flagged as hallucinated. This is detected by measuring the cosine distance between the input and output vectors. The further apart these vectors are in the vector space, the more likely the model is hallucinating content.

### 2. Groundedness

Groundedness focuses on verifying the factual correctness of the model's output. To assess groundedness, we rely on comparing the output with a pre-defined set of known facts or knowledge graphs. The cosine similarity between the model output and the reference facts ensures that the content generated by the model is rooted in truth, providing a reliable way to detect false information.

### 3. Relevance and Recall

Relevance and recall are both derived from concepts in information retrieval. Relevance measures how closely the generated output relates to the query, while recall measures how much of the relevant information has been retrieved. The technology uses embeddings of the input query and output to compute cosine similarity, ensuring that the response generated by the model is pertinent to the user's input.

### 4. Precision and Consistency

Precision evaluates the correctness of the retrieved information, minimizing the amount of incorrect or irrelevant information. Consistency, on the other hand, evaluates how uniform the model's responses are across different inputs. The technology uses the vector representations of inputs and outputs across different modalities to calculate consistency, ensuring that a model generates coherent outputs even when processing complex multimodal data.

### 5. Coherence

Coherence focuses on ensuring logical flow within the output. In text generation, for example, coherence ensures that consecutive sentences or paragraphs are meaningfully related to each other. In multimodal models, coherence also ensures that the text, image, and audio outputs align properly, creating a unified response. This is evaluated using semantic overlap measures between consecutive sentences or outputs across modalities.

### Optimization Framework

The optimization framework employed by the present technique is designed to automatically adjust model parameters based on the evaluation metrics. Using gradient-based optimization techniques, the system continuously fine-tunes the model to improve performance across all metrics.

The optimization framework in this technology ensures continuous improvement of model performance based on real-time evaluation. This framework leverages gradient-based optimization techniques that minimize the error function, which is a weighted combination of the evaluation metrics. The optimization process is designed to reduce hallucination and increase groundedness, relevance, consistency, and coherence.

The optimization logic is grounded in mathematical principles of gradient descent, where the gradient of the error function provides direction for minimizing errors. By adjusting model weights and parameters in real-time, the technology ensures that the model improves iteratively, focusing on areas where performance is lacking. Each metric is weighted according to its importance in the specific use case, allowing for fine-tuning of the model's evaluation across multiple dimensions.

### Example Implementation

### Implementation Using State-of-the-Art AI Tools

The technology is built using a combination of state-of-the-art AI tools, including:
Hugging Face Endpoint for model integration.
Qdrant Vector DB for similarity search and vector storage.
Amazon SageMaker for LLM training and optimization.
LangChain for managing multimodal inputs.

### Case Study: Multimodal Model Optimization for Healthcare

In a healthcare setting, the technology was used to optimize a multimodal model designed to generate clinical notes from patient images and speech inputs. By applying the evaluation metrics, the model's hallucination rate decreased by 12%, while its coherence and groundedness scores improved by 20% and 18%, respectively.

In a first aspect, the present disclosure may be embodied as a computer-implemented method 100 for evaluating and optimizing a large language model (LLM), which may be a multimodal LLM. The method 100 includes receiving 103, by a processor, input data for a large language model. The input data may include text, images, audio, video, or combinations thereof. The input data may be transformed 106, by the processor, into a standardized format compatible with a multi-metric evaluation framework.

The processor applies 109 a set of evaluation metrics to the transformed data. The set of metrics includes a hallucination metric (H), a groundedness metric (G), a relevance metric (R), a recall metric (Rec), a precision metric (P), a consistency metric (C), and a Coherence metric (Co).

The method 100 includes generating 112 an error function that quantifies an overall performance of the LLM, wherein the error function takes as input parameters of the LLM and incorporates the set of evaluation metrics to produce an error score. For example, the error function may be expressed as E(θ), where θ represents a set of parameters of the LLM, and the error function is made up of the set of evaluation metrics applied to the set of parameters of the LLM. In some embodiments, one or more evaluation metric of the set of evaluation metrics is weighted according to a corresponding predetermined weight (i.e., a corresponding number of weights may be provided).

The method 100 includes minimizing 115 the error function to provide a set of improved parameters. The error function may be minimized such that a lower error score indicates better performance of the LLM. In some embodiments, the error function may be minimized using a gradient descent optimization.

An improved LLM is outputted 118 by the processor. The improved LLM utilizes the set of improved parameters.

In another aspect, the present disclosure may be embodied as a system for evaluating and optimizing a large language model (LLM), such as, for example, a multimodal LLM. The system includes a processor. In some embodiments, the system may include a storage device in electronic communication with the processor.

The processor is configured (e.g., programmed, etc.) to perform any of the methods disclosed herein. For example, the processor may be programmed to receive input data for a large language model. The input data may include text, images, audio, video, or combinations thereof. The processor may be programmed to transform the input data into a standardized format compatible with a multi-metric evaluation framework.

The processor may apply a set of evaluation metrics to the transformed data. The set of metrics includes a hallucination metric (H), a groundedness metric (G), a relevance metric (R), a recall metric (Rec), a precision metric (P), a consistency metric (C), and a Coherence metric (Co).

The processor of the system may be programmed to generate an error function that quantifies an overall performance of the multimodal LLM, wherein the error function takes as input parameters of the multimodal LLM and incorporates the set of evaluation metrics to produce an error score. For example, the error function may be expressed as E(θ), where θ represents a set of parameters of the multimodal LLM, and the error function is made up of the set of evaluation metrics applied to the set of parameters of the multimodal LLM. In some embodiments, one or more evaluation metric of the set of evaluation metrics is weighted according to a corresponding predetermined weight (i.e., a corresponding number of weights may be provided).

The processor may be programmed to minimize the error function to provide a set of improved parameters. The error function may be minimized such that a lower error score indicates better performance of the multimodal LLM. In some embodiments, the error function may be minimized using a gradient descent optimizer.

The processor may be programmed to output an improved multimodal LLM. The improved multimodal LLM utilizes the set of improved parameters. For example, the processor may output the improved multimodal LLM by writing the improved multimodal LLM to a storage device.

The term processor is intended to be interpreted broadly. For example, in some embodiments, the processor includes one or more modules and/or components. Each module/component executed by the processor can be any combination of hardware-based module/component (e.g., graphics processing unit (GPU), a field-programmable gate array (FPGA), an application-specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general-purpose processor, a central processing unit (CPU), an accelerated processing unit (APU), a field-programmable gate array (FPGA), an application-specific integrated circuit (ASIC), a digital signal processor (DSP), graphics processing unit (GPU), microprocessor, controller, microcontroller, and/or the like.

Although the present disclosure has been described with respect to one or more particular embodiments, it will be understood that other embodiments of the present disclosure may be made without departing from the spirit and scope of the present disclosure.

What is claimed is:

1. A computer-implemented method for evaluating and optimizing a large language model (LLM), comprising:
receiving, by a processor, input data for a large language model;
transforming, by the processor, the input data into a standardized format compatible with a multi-metric evaluation framework;
applying, by the processor, a set of evaluation metrics to the transformed data, wherein the set of metrics comprises a hallucination metric (H), a groundedness metric (G), a relevance metric (R), a recall metric (Rec), a precision metric (P), a consistency metric (C), and a Coherence metric (Co);
generating, by the processor, an error function that quantifies an overall performance of the LLM, wherein the error function takes as input parameters of the LLM and incorporates the set of evaluation metrics to produce an error score;
minimizing the error function wherein a lower error score indicates better performance of the LLM; and
outputting, by the processor, an improved LLM with improved parameters.

2. The method of claim 1, wherein the input data comprises text, images, audio, video, or combinations thereof.

3. The method of claim 1, wherein the LLM is a multimodal LLM.

4. The method of claim 1, wherein minimizing the error function utilizes a gradient descent optimizer.

5. The method of claim 1, wherein the error function incorporates a set of pre-determined weights, each weight corresponding to a metric of the set of evaluation metrics.

6. The method of claim 1, wherein the hallucination metric is defined as:
$$H = \frac{Number of unsupported elements in output}{Total elements in output}$$

7. The method of claim 1, wherein the groundedness metric is defined as:
$$G = \frac{Number of verifiable facts in output}{Total number of facts present in output}$$

8. The method of claim 1, wherein the relevance metric is defined as:
$$R = cos θ = \frac{A \cdot B}{‖ A ‖ ‖ B ‖}$$

9. The method of claim 1, wherein the recall metric is defined as:
$$Recall = \frac{Number of Relevant Documents Retrieved}{Total Number of Documents in Corpus}$$

10. The method of claim 1, wherein the precision metric is defined as:
$$Precision = \frac{True Positives}{True Positives + False Negatives}$$

11. The method of claim 1, wherein the consistency metric is defined as:
$$C = 1 - \frac{Variance of outputs across inputs}{Mean of outputs across Inputs}$$

12. The method of claim 1, wherein the coherence metric is defined as:
$${C}_{o} = Discourse Coherence Score + Entity Tracking Accuracy$$

13. A system for evaluating and optimizing a large language model (LLM), the system comprising a processor configured to:
receive input data for a large language model;
transform the multimodal input data into a standardized format compatible with a multi-metric evaluation framework;
apply a set of evaluation metrics to the transformed data, wherein the set of metrics comprises a hallucination metric (H), a groundedness metric (G), a relevance metric (R), a recall metric (Rec), a precision metric (P), a consistency metric (C), and a Coherence metric (Co);
generate an error function that quantifies an overall performance of the LLM, wherein the error function takes as input parameters of the LLM and incorporates the set of evaluation metrics to produce an error score;
minimize the error function wherein a lower error score indicates better performance of the LLM; and
output an improved LLM with improved parameters.

14. The system of claim 13, wherein the input data comprises text, images, audio, video, or combinations thereof.

15. The system of claim 13, wherein the LLM is a multimodal LLM.

16. The system of claim 13, wherein minimizing the error function utilizes a gradient descent optimizer.

17. The system of claim 13, wherein the error function incorporates a set of pre-determined weights, each weight corresponding to a metric of the set of evaluation metrics.

18. The system of claim 13, wherein the hallucination metric is defined as:
$$H = \frac{Number of unsupported elements in output}{Total elements in output}$$

19. The system of claim 13, wherein the groundedness metric is defined as:
$$G = \frac{Number of verifiable facts in output}{Total number of facts present in output}$$

20. The system of claim 13, wherein the relevance metric is defined as:
$$R = cos θ = \frac{A \cdot B}{‖ A ‖ ‖ B ‖}$$

21. The system of claim 13, wherein the recall metric is defined as:
$$Recall = \frac{Number of Relevant Documents Retrieved}{Total Number of Documents in Corpus}$$

22. The system of claim 13, wherein the precision metric is defined as:
$$Precision = \frac{True Positives}{True Positives + False Negatives}$$

23. The system of claim 13, wherein the consistency metric is defined as:
$$C = 1 - \frac{Variance of outputs across inputs}{Mean of outputs across Inputs}$$

24. The system of claim 13, wherein the coherence metric is defined as:
$${C}_{o} = Discourse Coherence Score + Entity Tracking Accuracy$$

25. A system comprising:
a large language model integrated with generative AI, wherein the large language model is configured to generate a dynamic knowledge repository, and wherein the generative AI is configured to analyze the dynamic knowledge repository.

26. The system of claim 25, wherein the dynamic knowledge repository is generated from information that does not leave a user's network.

27. The system of claim 25, wherein the dynamic knowledge repository is generated from information that remains on a user's network.

28. The system of claim 25, wherein the dynamic knowledge repository is maintained on a user's network.

29. The system of claim 25, wherein the large language model is BERT, OpenAI, TS, PaLM, and/or LLaMA.

30. A method of using the system of claim 25.

31. A non-transitory computer readable medium storing a program configured to instruct a processor to execute the method of claim 25.
